(19) United States
(12) Patent Application Publication
(10) Pub. No.: US 2011/0044486 A1
(43) Pub. Date: Feb. 24, 2011

(54) PERSONAL BACK BASS SYSTEM

(76) Inventor: Gregory P. Borkowski, Marion, IN (US)

Correspondence Address: BAKER & DANIELS LLP, 300 NORTH MERIDIAN STREET, SUITE 2700, INDIANAPOLIS, IN, 46204, US

(21) Appl. No.: 12/852,958

(22) Filed: Aug. 9, 2010

Related U.S. Application Data
(60) Provisional application No. 61/236,324, filed on Aug. 24, 2009.

(51) Int. Cl. H04R 1/02

(52) U.S. Cl. 381/333

(57) ABSTRACT

A personal back bass system is provided in which the system includes a seat, a backrest, a subwoofer, and a subwoofer enclosure. The subwoofer is coupled to the backrest and is positioned so that the sound emitted from the subwoofer directly travels to the backrest such that the pressure from the subwoofer causes a visceral impact to the user of the personal back bass system.

### CLAIM FOR PRIORITY

The present application claims priority to U.S. Provisional Application 61/236,324 filed Aug. 24, 2009, the disclosure of which is incorporated herein by reference.

### FIELD

The present disclosure relates generally to an audio sound system. The present disclosure relates more specifically to a speaker system configured for use with a seat.

### BACKGROUND AND SUMMARY

Music is a source of enjoyment for many people. For some listeners, musical enjoyment heightens when the music is experienced by both listening and feeling the music. Visceral impacts imparted on a listener's body allow him or her to feel the bass frequencies as he or she listens to the music. However, listening to music traditionally requires speakers that are at some distance to the listener. With the source of the music and bass frequencies located away from the listener, he or she experiences few, if any, visceral impacts. Conventional methods of creating a visceral impact from music require a subwoofer. The volume on the subwoofer is turned up until the listeners feel a visceral impact from the music.

According to one embodiment of the present disclosure, a personal back bass system comprises a seat with a backrest. The backrest includes a fully-enclosed pocket of gas and a covering. The subwoofer is coupled to the backrest such that operation of the subwoofer imparts pressure to the fully-enclosed pocket of gas, thereby imparting pressure to the backrest that can be perceived by the user that is in contact with the covering of the backrest.

Additional features of the present disclosure will become apparent to those skilled in the art upon consideration of the following detailed description of the presently perceived best mode of carrying out the disclosure.

### BRIEF DESCRIPTION OF THE DRAWINGS

The detailed description of the drawings particularly refers to the accompanying figures in which:

FIG. 1 is a side view of the personal back bass system;

FIG. 2 is a side elevational view of a subwoofer.

### DETAILED DESCRIPTION OF THE DRAWINGS

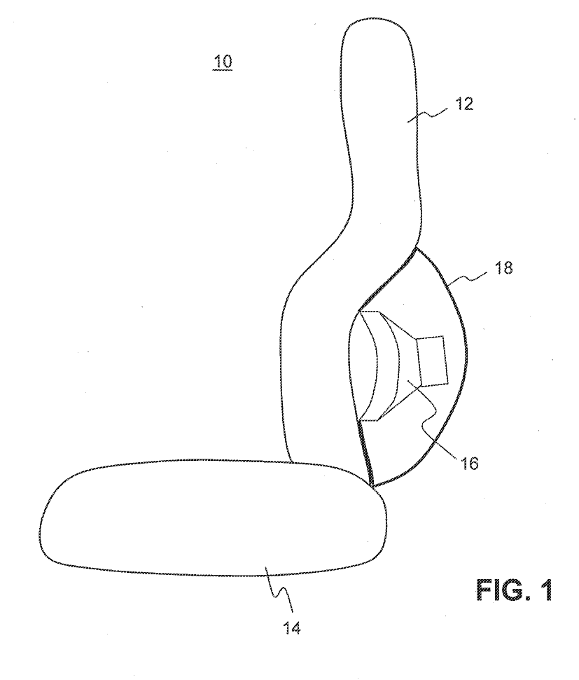

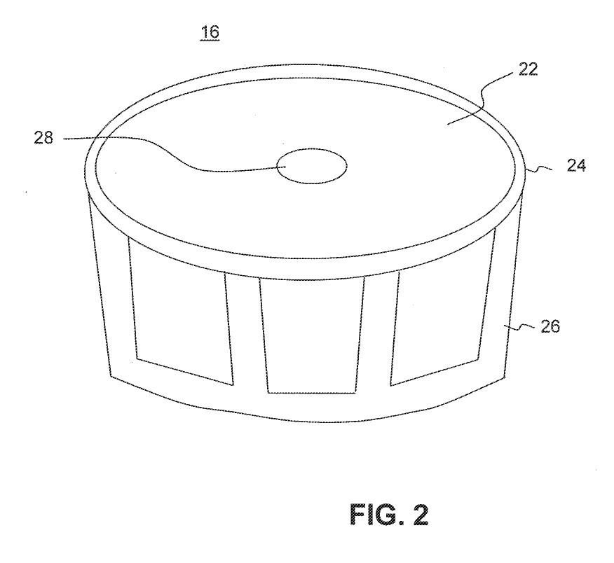

FIGS. 1 and 2 show personal back bass system 10 and subwoofer 16, respectively. Personal back bass system 10 includes seat 14, backrest 12, subwoofer 16, and subwoofer enclosure 18. Personal back bass system 10 can be an individual chair, such as a chair in a room or can be part of a larger collection of chairs, such as in a car or an auditorium.

FIG. 1 shows backrest 12 of the present embodiment which supports a user (not shown) and personal back bass system 10. Backrest 12 is comprised of a filler material, such as foam, that is capable of storing at least one pocket of gas. The filler material and pocket of gas are fully enclosed by a covering. Backrest 12 includes a front side that contacts the user of personal back bass system 10 and an opposing back side. With the pocket of gas fully enclosed, minimal amounts of gas flow into and out of the backrest. When using the personal back bass system, small amounts of the bass are naturally emitted from the backrest and heard by the user. However, there are no defined outlets within backrest 12 or personal back bass system 10 for sound or enclosed air to be emitted. Backrest 12, shown in FIG. 1, is connected to seat 14 using conventional fasteners and conventional means.

A subwoofer is generally a speaker that reproduces low-bass frequencies. Low-bass frequencies are frequencies such as those between 20-100 Hz. While frequency ranges are used herein, it should be appreciated that such ranges are illustrative and not bright line boundaries. A subwoofer is comprised of a diaphragm, which emits the sound from the subwoofer.

FIG. 1 shows subwoofer 16 coupled to the back side of backrest 12. Subwoofer 16 does not extend beyond the width of backrest 12 and is positioned such that diaphragm 22, as seen in FIG. 2, is adjacent to the back side of the backrest 12. With this positioning, the vibrations emitted from diaphragm 22 of subwoofer 16 are directed to backrest 12. As the vibrations contact the back side of backrest 12, the pocket of gas enclosed in backrest 12 transmits these vibrations to the front side of backrest 12, thereby allowing the user of personal back bass system 10 to feel the vibrations. Since there is minimal or negligible airflow out of backrest 12, the substantially full pressure of the vibrations is felt by the user of personal back bass system 10.

Subwoofer 16 receives audio signals in the low- to mid-bass frequency range. Personal back bass system 10 is configured for use with conventional speakers, such as left and right speakers, and optionally, surround sound speakers. In this arrangement, the bass frequencies from personal back bass system 10 are separated, or filtered, from the audio signals sent to the stereo or surround-sound speakers via filters such as crossover filters. The slopes of the crossover filters are illustratively 24 decibels/octave or greater to avoid overlapping the frequency spectra of subwoofer 16 and the conventional speakers. When personal back bass system 10 is used in conjunction with conventional speakers, subwoofer 16 does not reproduce substantial upper bass. Upper bass frequencies are frequencies such as those 120 Hz or greater. If subwoofer 16 produced upper bass, over-emphasizing of deep male voices can occur, leading to voice coloration and resulting in a potentially unpleasant sound to the listener.

Optionally, remote subwoofers, such as ultra-low frequency (ULF) subwoofers (not shown), can be used with the personal back bass system. The ULF subwoofers are added to personal back bass system 10 if subwoofer 16 is small. Small subwoofers 16 are unlikely to be capable of producing the lowest audible frequency possible. However, when combined, a small subwoofer and the ULF subwoofers produce a full spectrum of the low audible frequencies.

Speaker enclosures can affect how sound is produced. A sealed enclosure ensures that minimal, if any, air is emitted from the enclosure. Therefore, the sound is projected from the diaphragm directly to the area in front of the diaphragm or is trapped within the enclosure. In this way, the bass felt and heard by the listener is more responsive (i.e. “tight”) than that of a vented subwoofer enclosure design, which resonates a mass of air inside a port or vent, with resonance lingering beyond the duration of the original audio signal.

Subwoofer 16 is surrounded by sealed enclosure 18, which is coupled to the back side of backrest 12. As such, a substantial seal is formed between enclosure 18 and the back side of backrest 12 to prevent significant airflow out of subwoofer 16 and away from backrest 12. The bass emitted from diaphragm 22 is transmitted to backrest 12 or stays within subwoofer enclosure 18.

It should be appreciated that while the present disclosure discussed subwoofer 16 as being positioned on the back of backrest 12, embodiments are envisioned where subwoofer 16 is integral with and inside of backrest 12.

Personal back bass system 10 is equipped with a local level control (not shown) for fine-tuning the level of bass heard by the listener. The local level control allows for personal preferences with respect to the visceral impacts imparted to the listener's back. The local level control may be adjusted from 0% to 100% of the bass emitted from subwoofer 16.

Although the disclosure has been described in detail with reference to a certain preferred embodiment, variations and modifications exist within the spirit and scope of the disclosure as described and defined in the following claims.

1. A personal back bass system comprising:
a seat having a backrest, the backrest having an enclosed subwoofer mounted therein, the backrest further including
a covering, and
at least one discrete fully enclosed pocket of gas within the covering, the subwoofer being positioned such that operation of the subwoofer imparts pressure to the at least one fully enclosed pocket of gas which, in turn, imparts pressure to the covering to permit tactile perception of the pressure by a seated user.

2. The personal back bass system of claim 1 wherein the subwoofer is coupled to a back side of the backrest such that a diaphragm is positioned adjacent to the back side of the backrest.

3. The personal back bass system of claim 2 wherein the subwoofer is fully covered by a subwoofer enclosure that is coupled to the back side of the backrest to substantially seal the subwoofer enclosure to the backrest so that minimal sound is emitted from the subwoofer enclosure.

4. The personal back bass system of claim 1 wherein the subwoofer receives bass signals up to 100 Hz in frequency.

5. The personal back bass system of claim 1 wherein a slope of an electronic filter is at least 24 decibels/octave to reduce bass signals in a mid- to upper-range.

6. The personal back bass system of claim 1 wherein at least one stereo speaker is used in conjunction with the personal back bass system such that frequencies up to 100 Hz are filtered from audio signals received by the at least one stereo speaker.

7. The personal back bass system of claim 1 wherein at least one surround-sound speaker is used in conjunction with the personal back bass system such that frequencies up to 100 Hz are filtered from audio signals received by the at least one surround-sound speaker.

8. The personal back bass system of claim 4 wherein the seat has an independent local level control to adjust the bass signals to a particular preference.

9. The personal back bass system of claim 3, wherein the subwoofer enclosure is comprised of a fiberglass composite material.

10. The personal back bass system of claim 1 wherein at least one ultra-low frequency subwoofer is used in conjunction with the personal back bass system to reproduce the lowest octave of music.

11. The personal back bass system of claim 1 wherein the seat is comprised of foam.

12. The personal back bass system of claim 1 wherein the seat is in a vehicle.

13. The personal back bass system of claim 1 wherein the seat is a chair in a room.

14. The personal back bass system of claim 1 wherein the seat is a chair in an auditorium.
